(19) United States
(12) Patent Application Publication
(10) Pub. No.: US 2004/0217513 A1
(43) Pub. Date: Nov. 4, 2004

(54) Process for producing polyurethane moldings

(76) Inventors: Jurgen Wirth, Koln (DE); Wolfgang Pawlik, Koln (DE); Oliver Girnstein, Katharinen (DE)

Correspondence Address: BAYER MATERIAL SCIENCE LLC, 100 BAYER ROAD, PITTSBURGH, PA, 15205, US

(21) Appl. No.: 10/777,495

(22) Filed: Feb. 12, 2004

(30) Foreign Application Priority Data
Feb. 14, 2003 (DE) 10306523.7

(51) Int. Cl. B29C 31/00

(52) U.S. Cl. 264/240

(57) ABSTRACT

Polyurethane moldings are produced by conveying in shot operation at least one isocyanate component and at least one polyol component for a predetermined time-interval Δt into a mixing chamber with predetermined volumetric flow-rates \dot{V}_{s/iso} for the isocyanate and \dot{V}_{s/polyol} for the polyol and with predetermined pressures p_{s/iso} for the isocyanate and p_{s/polyol} for the polyol, mixing those components in a mixing chamber, and discharging the polyurethane reaction mixture into a mold. Prior to shot operation, the components are conveyed in a circuit through circulation lines between the mixing head and the respective component storage vessels. The pressures of the components are measured by means of pressure sensors and are transmitted via pulse lines to a control device. During conveyance in the circuit, the volumetric flow-rates of the components are adjusted in such a way that the pressures of the components in the circuit correspond to the predetermined pressures p_{s/iso} and p_{s/polyol} of the components for shot operation. During the change-over from circulatory mode of operation to shot operation, the predetermined volumetric flow-rates \dot{V}_{s/iso} and \dot{V}_{s/polyol} of the components are adjusted for shot operation. The adjustment of the volumetric flow-rates of the components may be effected by the control device by adjusting the drive units of the metering elements.

### BACKGROUND OF THE INVENTION

The present invention relates to a process for producing polyurethane moldings in which the reaction components are mixed under high pressure in a mixing head and a distortion of the mixing ratio in the course of changing over from circulatory mode of operation to shot operation is avoided.

Recirculation mixing heads operate only within a narrowly limited performance range without a change in pressure in the course of changing over from circulatory mode of operation to shot operation.

Particularly in the case of high viscosities and large ranges of the discharge capacity, differences in the pressure of the flowing components arise between shot operation and circulatory operation, since the flow resistances of the structural elements that are employed are throughput-dependent and viscosity-dependent. At present, these differences in pressure between circulatory operation and shot operation, and the associated consequences, have to be tolerated.

Against the background of heightened quality requirements, such as DIN ISO 9001 for example, evidence of process efficiency is also demanded of the production plants that are employed for the production of polyurethanes. This evidence cannot at present be furnished satisfactorily.

The production of moldings from polyurethane is undertaken by means of a so-called reaction injection molding machine. In this case, at least two reactive components that react with one another (isocyanate and polyol) are supplied in a predetermined mixing ratio to a mixing head via pipelines and hose lines. The respective volumetric flow-rates, and therefore the mixing ratio of the two reactive components, are predetermined in this case by the metering units.

The mixing head is ordinarily constructed in the form of a recirculation mixing head. This means that the reactive components are recycled via the mixing head prior to the actual mixing process (shot or shot operation), in which connection the volumetric flow-rates and also the pressures that are required for the purpose of metering or mixing have already been adjusted exactly during recirculation.

Located in the mixing head are the mixing nozzles and also the change-over elements which change the plant over from circulatory mode of operation to shot operation or vice versa. In the course of changing over from circulatory mode of operation to shot operation, the recirculation of the components is interrupted and the components are channelled into the mixing chamber and into the adjoining discharge pipe of the mixing head, right into the mold.

The metering process is subdivided into the two phases constituted by recirculation and shot.

In the course of changing over from recirculation (circulatory mode of operation) to shot operation, the change-over elements, for example a grooved slide or, depending on the type of mixing head employed, some other suitable change-over elements, are hydraulically switched very quickly. The volumetric flow-rates and the pressures of the components being conveyed should ideally remain the same during and after this change.

In practice, however, particularly in the course of mixing highly viscous components in high-pressure mixing heads, changes in the pressure of the components frequently occur in the course of changing over from the circulatory mode of operation to shot operation. This has the consequence that the volumetric flow-rates of the components also change. This is due to the elasticity of the hose lines and also to the compressibility of the components. This process is also described as “exhaling”. A change in the volumetric flow-rates brings about, in turn, an incorrect mixing ratio and therefore the production of reject moldings, or at least moldings of lesser quality.

The pressure of the components is determined by the throughput-dependent and viscosity-dependent loss of pressure of the components in the course of flowing through the lines and the built-in structural elements, for example the pressure-adjusting elements such as nozzles and throttles. The loss of pressure of the conventional pressure-adjusting elements that is generated is a function of the throughput.

In addition to the loss of pressure in the recirculation phase, which is generated by the pressure-adjusting elements being flowed through, other flow resistances take effect which generate an additional loss of pressure. These are, substantially, the flow resistances that are generated by the return line (circulation line) or that arise in the course of flowing through channels pertaining to the change-over elements (circulatory grooves). These flow resistances are also a function of the throughput.

During recirculation, flow resistances consequently arise that differ from those during shot operation, since during recirculation in some cases lines and structural elements are flowed through that differ from those during shot operation, such as the circulatory grooves and the return lines, for example.

Therefore changes in pressure occur in the course of changing over from the circulatory mode of operation to shot operation. These changes occur, in particular, in the case of high component viscosities and in the case of large ranges of the discharge capacities, since the flow resistances are viscosity-dependent and throughput-dependent. As a result, changes then occur in the volumetric flow-rates, and hence a change occurs in the mixing ratio of the components, which can impair the quality of the molding, even going so far as to result in rejects.

### SUMMARY OF THE INVENTION

The object of the present invention is therefore to provide a process for producing polyurethane moldings in which a distortion of the mixing ratio can be avoided in the course of changing over from circulatory mode of operation to shot operation.

### BRIEF DESCRIPTION OF THE DRAWINGS

FIG. 1 shows a plant for producing polyurethane moldings in recirculation operation.

FIG. 2 shows a plant for producing polyurethane moldings in shot operation.

FIG. 3 shows both a pressure profile and a volumetric-flow-rate profile as a function of time according to the state of the art process.

FIG. 4 shows the profiles of pressure and volumetric flow-rate according to the process according to the invention.

### DETAILED DESCRIPTION OF THE INVENTION

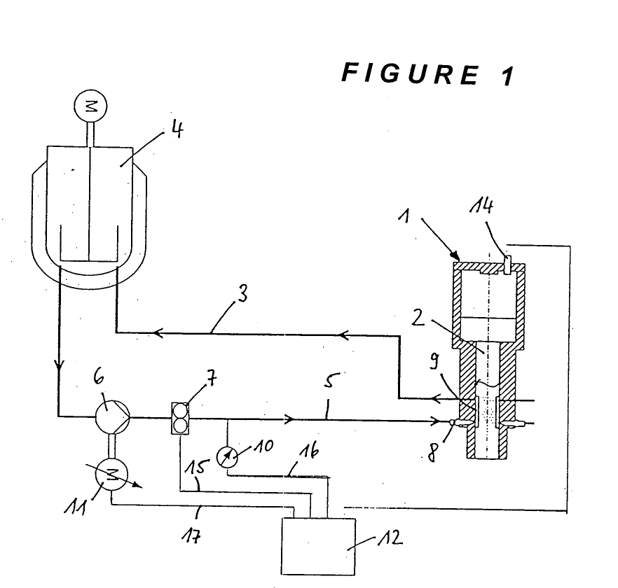

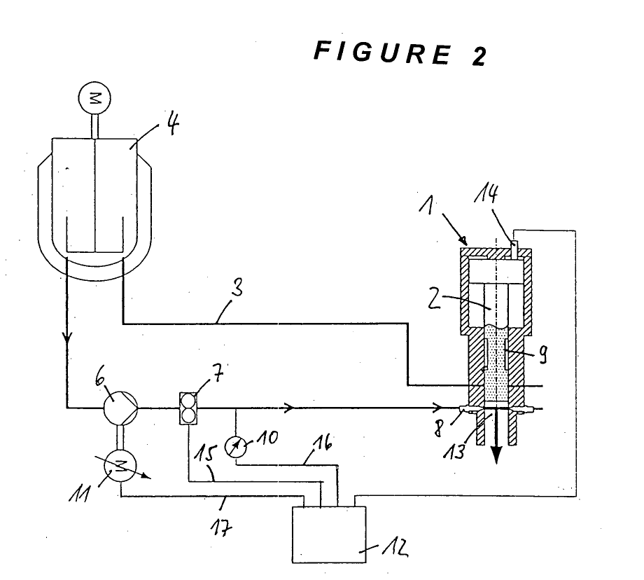

The invention relates to a process for producing polyurethane moldings in which in shot operation at least one isocyanate component and at least one polyol component are conveyed for a predetermined time-interval Δt into a mixing chamber 13 (shown in FIG. 2) with predetermined volumetric flow-rates \dot{V}_{s/iso} for the isocyanate and \dot{V}_{s/polyol} for the polyol and with predetermined pressures p_{s/iso} for the isocyanate and p_{s/polyol} for the polyol, are mixed in the mixing chamber 13, and the polyurethane reaction mixture is 10 subsequently discharged into a mold, and wherein prior to shot operation the components are conveyed in a circuit through circulation lines 3 (shown in FIGS. 1 and 2) between the mixing head and the respectively assigned component containers 4 (FIGS. 1 and 2), characterised in that the pressures of the components are measured by means of pressure sensors 10 (FIG. 1) and are transmitted via pulse lines 16 to a control device 12 and in that during the conveying in the circuit, the volumetric flow-rates of the components are adjusted in such a way that the pressures of the components in the circuit correspond to the predetermined pressures p_{s/iso} and p_{s/polyol} of the components for shot operation, and in that during the change-over from circulatory mode of operation to shot operation the predetermined volumetric flow-rates \dot{V}_{s/iso} and \dot{V}_{s/polyol} of the components are adjusted for shot operation, the adjustment of the volumetric flow-rates of the components being effected by the adjustment of the drive units 11 of the metering elements 6 (FIG. 1) by the control device 12.

So in the process according to the invention, no attempt is made to adjust the pressure and the metered volumetric flow-rate during the recirculation phase to the values that correspond to the values in shot operation. Rather, the volumetric flow-rate in the recirculation phase is adjusted in such a way that the pressure resulting during recirculation corresponds to the pressure that is demanded for shot operation. The metered volumetric flow-rate is not adjusted until the change-over elements change over from circulatory mode of operation to shot operation.

This manner of proceeding becomes possible by virtue of the fact that the adjustment of the volumetric flow-rate of the metering elements is undertaken at the time when the change-over elements change over from circulatory mode of operation to shot operation. For this purpose, the drive unit of the metering element is regulated by a control device which receives analogue values of the pressure sensors and of the volumetric-flow meter and also a status message of the change-over elements.

The control device requires a number of items of information to regulate the drive unit of the metering element:

First of all, the machine is set up. This means that in the circulatory mode of operation, the characteristic curves for the pressure and for the mass flow-rate or volumetric flow-rate are recorded as a function of the pump speed and are saved in the control device.

With the first shot, the shot pressures p_{s/iso} and p_{s/polyol} for a fixed mass flow-rate or volumetric flow-rate in shot operation are ascertained and are likewise saved in the control system.

If a further shot is to be carried out under the same conditions, the control device in the circulatory mode of operation adjusts a conveying capacity of the metering elements (for example, pump speeds) that corresponds to the saved shot pressures p_{s/iso} and p_{s/polyol}.

At the moment of change-over from the circulatory mode of operation to shot operation, the conveying capacity that corresponds to the demanded metering capacity for shot operation is then adjusted (for example, by adjustment of the pump speed).

In a preferred embodiment of the invention, individual pairs of values of shot data (that is to say, the conveying capacity to be adjusted in the given case in the circulatory mode of operation and shot pressures p_{i/iso} and p_{s/polyol}) relating to a dynamic characteristic curve are interpolated. Hence the control system of the plant then has data available for pressure settings that have not previously been put into effect as a shot.

The invention will be elucidated in more detail in the following on the basis of the Figures.

FIG. 1 shows in exemplary manner a plant for use in the process according to the invention, including a counterflow injection mixing head 1, the change-over element 2 which may take the form of a grooved slide or control slide valve. The component (isocyanate or polyol) is conveyed in a circuit through circulation line 3, component container 4, line 5, metering pump 6, volumetric-flow meter 7, nozzle 8 and circulatory groove 9. The other component is conveyed in an analogous manner (not shown). The measurement of pressure is undertaken by pressure sensor 10 which is connected to the control device 12 via a pulse line 16. The metering pump 6 is driven by a motor 11 which is likewise connected to the control device 12 via a pulse line 17. The volumetric-flow meter 7 is likewise connected to the control device 12 via a pulse line 15. Initiator/proximity switch 14 which is connected to the control device 12 communicates the actual position of the change-over element 2 to control device 12. The position of change-over element 2 indicates whether the plant is in circulatory mode of operation or in shot operation.

The metering process is subdivided into the two phases constituted by recirculation and shot.

In the course of changing over from recirculation (circulatory mode of operation) to shot operation, the change-over element 2 (grooved slide) is hydraulically changed over very quickly.

FIG. 2 shows the same plant in shot operation. The control slide valve (change-over element 2) blocks the return flow into the circulation line 3. The component is therefore conveyed through the nozzle 8 into the mixing chamber 13 and is mixed therein with the second component.

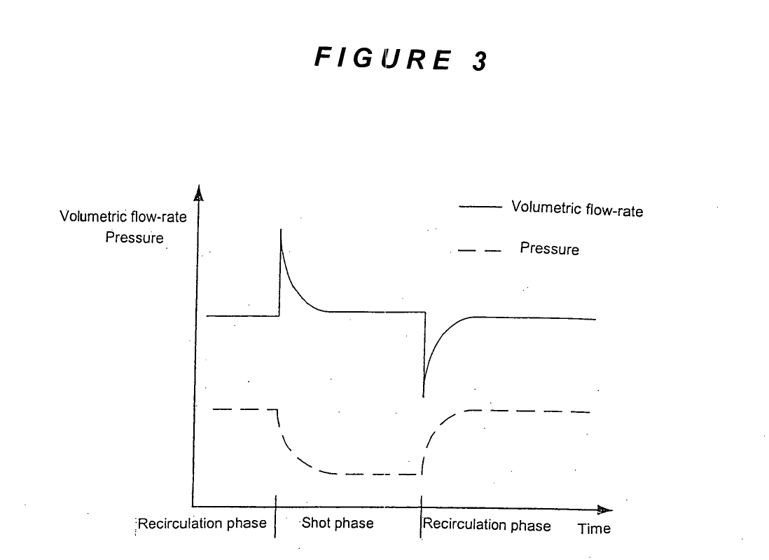

FIG. 3 shows both a pressure profile and a volumetric-flow-rate profile as a function of time according to the state of the art process. A considerable change in pressure is evident in the course of changing over from the circulatory mode of operation to shot operation. By virtue of the “exhaling” of the pressure system, the volumetric flow-rate changes over the shot time.

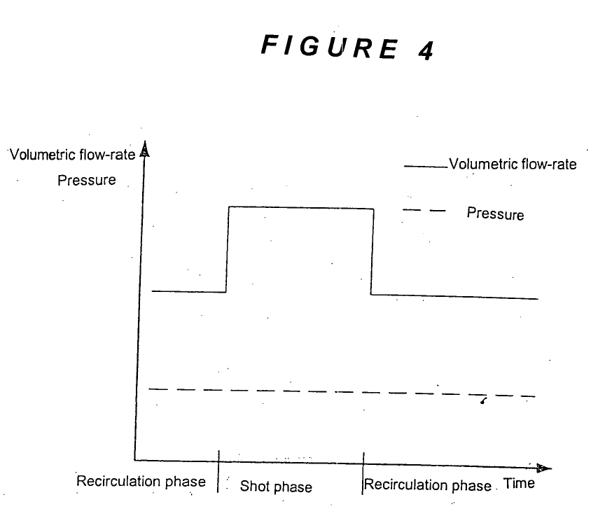

FIG. 4 shows the profiles of pressure and volumetric flow-rate according to the process according to the invention. Here the pressure profile is constant during the entire recirculation and shot phases. The volumetric flow-rate is constant during the entire shot time.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing a polyurethane molding comprising:
a) conveying in shot operation at least one isocyanate component and at least one polyol component for a predetermined time-interval Δt into a mixing chamber at predetermined volumetric flow-rate \dot{V}_{s/iso} for the isocyanate and \dot{V}_{s/polyol} for the polyol and predetermined pressure p_{s/iso} for the isocyanate and p_{s/polyol} for the polyol,
b) mixing the isocyanate and polyol in the mixing chamber to form a polyurethane reaction mixture, and
c) discharging the polyurethane reaction mixture into a mold, and in which
(1) prior to a), the isocyanate and polyol are conveyed in circuit through circulation lines between the mixing chamber and their respective storage vessels,
(2) the pressure of the isocyanate and of the polyol are measured by means of pressure sensors and transmitted to a control device,
(3) the volumetric flow-rates of the isocyanate and polyol are adjusted while being conveyed through the circulation lines in such a way that the pressure of each of the isocyanate and polyol in the circuit corresponds to the predetermined pressures p_{s/iso} and p_{s/polyol} of the components for shot operation, and
(4) the volumetric flow-rates \dot{V}_{s/iso} and \dot{V}_{s/polyol} of the isocyanate and polyol are adjusted by the control device during change-over from circulatory mode of operation to shot operation by adjustment of drive units of metering elements for the isocyanate and polyol.

2. The process of claim 1 in which reactive components and/or additives in addition to the polyol and isocyanate are employed.

3. The process of claim 2 in which a dye is employed.

4. The process of claim 1 in which the pressure of the isocyanate and of the polyol both during recirculation and during shot operation lie within a range from 3 bar to 600 bar.

5. The process of claim 1 in which the pressure of the isocyanate and of the polyol both during recirculation and shot operation lie within a range of from 50 bar to 350 bar.

6. The process of claim 1 in which the pressure of the isocyanate and of the polyol both during recirculation and shot operation lie within a range of from 100 bar to 250 bar.

7. The process of claim 1 in which the volumetric flow-rate of the isocyanate and of the polyol are registered permanently by a volumetric-flow meter, the flow-rates are signalled to the control system by means of a pulse line and any flow-rate exceeding a set tolerance which arises during a shot is ascertained and corrected for subsequent shots.
